(19) United States
(12) Patent Application Publication
(10) Pub. No.: US 2024/0257205 A1
(43) Pub. Date: Aug. 1, 2024

(54) SYSTEMS AND METHODS FOR VARIANT ITEM RECOMMENDATION

(71) Applicant: Walmart Apollo, LLC, Bentonville, AR (US)

(72) Inventors: Kritika Upreti, Sunnyvale, CA (US); Yanbing Xue, Sunnyvale, CA (US); Rithvik Reddy Ananth, Santa Clara, CA (US); Mohit Prakash Patel, San Jose, CA (US); Jayanth Korlimarla, Sunnyvale, CA (US); Musen Wen, Mountain View, CA (US)

(21) Appl. No.: 18/104,072

(22) Filed: Jan. 31, 2023

(51) Int. Cl. G06Q 30/0601

(52) U.S. Cl. CPC G06Q 30/0629; G06Q 30/0631; G06Q 30/0641

(57) ABSTRACT

Systems and methods of generating interfaces including variant item recommendations are disclosed. A request for an interface and a set of candidate items selected from an item catalog are received. At least one of the candidate items is representative of two or more variant items. A variant score is determined for each variant item related to the at least one of the candidate items and a set of recommended items is generated by independently ranking each item in the set of candidate items and each of the two or more variant items. The set of recommended items is generated by a variant-aware ranking model configured to receive the variant score for each variant item and based on the variant score and a relevancy score for each variant item. The interface including the set of recommended items is generated and transmitted to a system that generated the request for the interface.

### TECHNICAL FIELD

This application relates generally to interface generation, and more particularly, to interface generation including variant items.

### BACKGROUND

Electronic catalogs of items associated with network environments can include thousands or millions of items. Items included in electronic catalogs can include variant items, e.g., similar items having variations in one or more parameters. As one example, in the context of an e-commerce environment, an electronic catalog of items can include variant items having different sizes, colors, or other features that provide variation but do not themselves define a separate item.

In order to manage searching and presentation of results from electronic catalogs, current search systems retrieve and present only a single version of any product from the catalog. For example, an item catalog can include multiple variants of a first product, such as a shirt, in various colors and/or sizes. Current search systems will return only a single, most-common variant of the shirt, such that any search that returns the search will show the same version. Current systems do not match variants of items to search queries or intents.

### SUMMARY

In various embodiments, a system is disclosed. The system includes a non-transitory memory and a processor communicatively coupled to the non-transitory memory. The processor is configured to read a set of instructions to receive a request for an interface and receive a set of candidate items selected from an item catalog. At least one of the candidate items is representative of two or more variant items in the item catalog. The processor is further configured to read the set of instructions to determine a variant score for each variant item related to the at least one of the candidate items and generate a set of recommended items by independently ranking each item in the set of candidate items and each of the two or more variant items. The set of recommended items is generated by a variant-aware ranking model configured to receive the variant score for each variant item and based on the variant score and a relevancy score for each variant item. The processor is further configured to read the set of instructions to generate the interface including the set of recommended items and transmit the interface to a system that generated the request for the interface.

In various embodiments, a computer-implemented method is disclosed. The computer-implemented method includes steps of receiving a request for an interface and receiving a set of candidate items selected from an item catalog. At least one of the candidate items is representative of two or more variant items in the item catalog. The computer-implemented method further includes steps of determining a variant score for each variant item related to the at least one of the candidate items and generating a set of recommended items by independently ranking each item in the set of candidate items and each of the two or more variant items. The set of recommended items is generated by a variant-aware ranking model configured to receive the variant score for each variant item and based on a relevancy score for each variant item. The computer-implemented method further includes steps of generating the interface including the set of recommended items and transmitting the interface to a system that generated the request for the interface.

In various embodiments, a non-transitory computer-readable medium having instructions stored thereon is disclosed. The instruction, when executed by a processor, cause a device to perform operations including receiving a request for an interface and receiving a set of candidate items selected from an item catalog. At least one of the candidate items is representative of two or more variant items in the item catalog. The instruction, when executed by a processor, cause the device to perform further operations including determining a variant score for each variant item related to the at least one of the candidate items and generating a set of recommended items by independently ranking each item in the set of candidate items and each of the two or more variant items. The set of recommended items is generated by a variant-aware ranking model configured to receive the variant score for each variant item and based on a relevancy score for each variant item. The instruction, when executed by a processor, cause the device to perform further operations including generating the interface including the set of recommended items and transmitting the interface to a system that generated the request for the interface.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a computer system configured to implement one or more processes, in accordance with some embodiments.

FIG. 2 illustrates a network environment configured to provide a network interface including one or more variant item elements generated by a variant generation system, in accordance with some embodiments.

FIG. 3 illustrates an artificial neural network, in accordance with some embodiments.

FIG. 4 illustrates a tree-based neural network, in accordance with some embodiments.

FIG. 5 is a flowchart illustrating a method of generating an interface including one or more variant items, in accordance with some embodiments.

FIG. 6 is a process flow illustrating various steps of the method of generating an interface including one or more variant items, in accordance with some embodiments.

FIG. 7 illustrates an interface including content elements representative of variant items, in accordance with some embodiments.

FIG. 8 is a flowchart illustrating a method of generating a trained machine learning model, in accordance with some embodiments.

FIG. 9 is a process flow illustrating various steps of the method of generating a trained machine learning model, in accordance with some embodiments.

### DETAILED DESCRIPTION

This description of the exemplary embodiments is intended to be read in connection with the accompanying drawings, which are to be considered part of the entire written description. The drawing figures are not necessarily to scale and certain features of the invention may be shown exaggerated in scale or in somewhat schematic form in the interest of clarity and conciseness. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein can be assigned to the other claimed objects and vice versa. In other words, claims for the systems can be improved with features described or claimed in the context of the methods. In this case, the functional features of the method are embodied by objective units of the systems.

Furthermore, in the following, various embodiments are described with respect to methods and systems for generating interfaces including variant items. In various embodiments, a system for generating an interface includes a variant generation system configured to identify variant items for inclusion in network interfaces. The variant generation system is configured to receive a set of items identified, for example, by a traditional search engine and identify variant items that are potential candidate results for a search request. The set of items and the identified variant items are provided to a ranking module that is configured to rank the variant items independent of and/or in addition to a corresponding item in the set of items. A set of recommended items including at least one variant item is provided for inclusion in a generated interface.

In some embodiments, systems, and methods for generating an interface including at least one variant item includes a trained variant-aware ranking model configured to individually and/or independently rank variant items to select variant items having a better match to a user intent. The trained variant-aware ranking model is configured to differentiate variations of items, e.g., avoid over and/or under ranking items as a group. The variant-aware ranking model is configured to receive a set of variants selected based on a calculated variant popularity score. In some embodiments, a trained variant-aware ranking model is configured to receive a variant score and a relevance score and generate a ranked set of recommended items for inclusion within an interface.

In general, a trained function mimics cognitive functions that humans associate with other human minds. In particular, by training based on training data the trained function is able to adapt to new circumstances and to detect and extrapolate patterns.

In general, parameters of a trained function can be adapted by means of training. In particular, a combination of supervised training, semi-supervised training, unsupervised training, reinforcement learning and/or active learning can be used. Furthermore, representation learning (an alternative term is “feature learning”) can be used. In particular, the parameters of the trained functions can be adapted iteratively by several steps of training.

In particular, a trained function can comprise a neural network, a support vector machine, a decision tree and/or a Bayesian network, and/or the trained function can be based on k-means clustering, Qlearning, genetic algorithms and/or association rules. In particular, a neural network can be a deep neural network, a convolutional neural network, or a convolutional deep neural network. Furthermore, a neural network can be an adversarial network, a deep adversarial network and/or a generative adversarial network.

In various embodiments, a neural network which is trained (e.g., configured or adapted) to generate a set of recommended items including variant items, is disclosed. A neural network trained to generate ranked sets of recommended items for inclusion in an interface including variant items may be referred to as a trained variant-aware ranking model and/or a trained variant ranking model. The trained variant-aware ranking model can be configured to generate sets of recommended items based on a combination of a variant score and a relevance score. In some embodiments, a relevance score is calculated for an item globally, e.g., a relevance score is determined for a single representative item variant for an item having multiple variants and a variant score is calculated for a specific variant. The variant score can be representative of a match between an item variant and a user intent and/or a search query, as discussed in greater detail below.

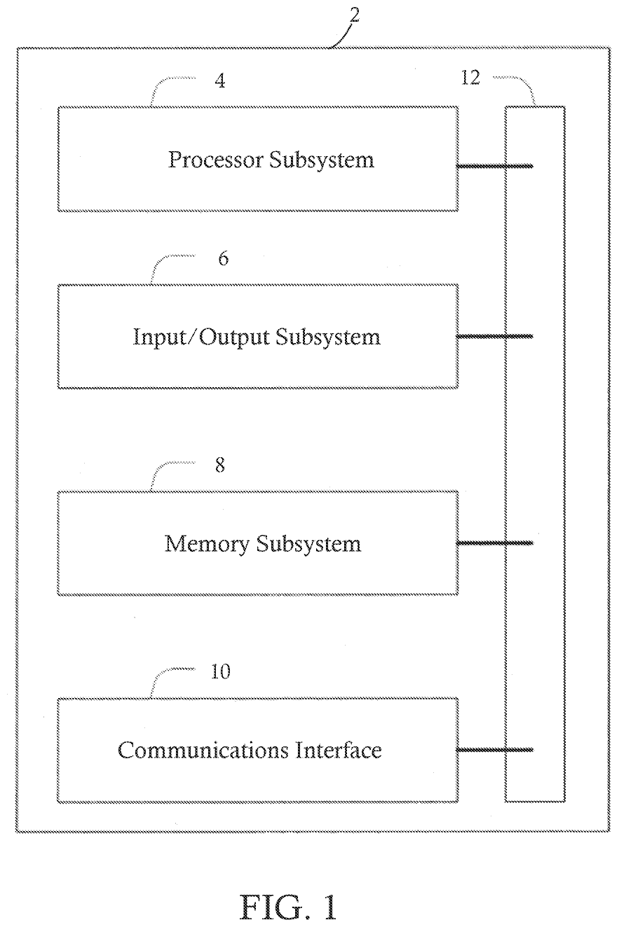

FIG. 1 illustrates a computer system configured to implement one or more processes, in accordance with some embodiments. The system 2 is a representative device and can include a processor subsystem 4, an input/output subsystem 6, a memory subsystem 8, a communications interface 10, and a system bus 12. In some embodiments, one or more than one of the system 2 components can be combined or omitted such as, for example, not including an input/output subsystem 6. In some embodiments, the system 2 can include other components not combined or comprised in those shown in FIG. 1. For example, the system 2 can also include, for example, a power subsystem. In other embodiments, the system 2 can include several instances of the components shown in FIG. 1. For example, the system 2 can include multiple memory subsystems 8. For the sake of conciseness and clarity, and not limitation, one of each of the components is shown in FIG. 1.

The processor subsystem 4 can include any processing circuitry operative to control the operations and performance of the system 2. In various aspects, the processor subsystem 4 can be implemented as a general purpose processor, a chip multiprocessor (CMP), a dedicated processor, an embedded processor, a digital signal processor (DSP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The processor subsystem 4 also can be implemented by a controller, a microcontroller, an application specific integrated circuit (ASIC), a field programmable gate array (FPGA), a programmable logic device (PLD), and so forth.

In various aspects, the processor subsystem 4 can be arranged to run an operating system (OS) and various applications. Examples of an OS comprise, for example, operating systems generally known under the trade name of Apple OS, Microsoft Windows OS, Android OS, Linux OS, and any other proprietary or open-source OS. Examples of applications comprise, for example, network applications, local applications, data input/output applications, user interaction applications, etc.

In some embodiments, the system 2 can include a system bus 12 that couples various system components including the processor subsystem 4, the input/output subsystem 6, and the memory subsystem 8. The system bus 12 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for computing device applications.

In some embodiments, the input/output subsystem 6 can include any suitable mechanism or component to enable a user to provide input to system 2 and the system 2 to provide output to the user. For example, the input/output subsystem 6 can include any suitable input mechanism, including but not limited to, a button, keypad, keyboard, click wheel, touch screen, motion sensor, microphone, camera, etc.

In some embodiments, the input/output subsystem 6 can include a visual peripheral output device for providing a display visible to the user. For example, the visual peripheral output device can include a screen such as, for example, a Liquid Crystal Display (LCD) screen. As another example, the visual peripheral output device can include a movable display or projecting system for providing a display of content on a surface remote from the system 2. In some embodiments, the visual peripheral output device can include a coder/decoder, also known as Codecs, to convert digital media data into analog signals. For example, the visual peripheral output device can include video Codecs, audio Codecs, or any other suitable type of Codec.

The visual peripheral output device can include display drivers, circuitry for driving display drivers, or both. The visual peripheral output device can be operative to display content under the direction of the processor subsystem 4. For example, the visual peripheral output device may be able to play media playback information, application screens for application implemented on the system 2, information regarding ongoing communications operations, information regarding incoming communications requests, or device operation screens, to name only a few.

In some embodiments, the communications interface 10 can include any suitable hardware, software, or combination of hardware and software that is capable of coupling the system 2 to one or more networks and/or additional devices. The communications interface 10 can be arranged to operate with any suitable technique for controlling information signals using a desired set of communications protocols, services, or operating procedures. The communications interface 10 can include the appropriate physical connectors to connect with a corresponding communications medium, whether wired or wireless.

Vehicles of communication comprise a network. In various aspects, the network can include local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments comprise in-body communications, various devices, and various modes of communications such as wireless communications, wired communications, and combinations of the same.

Wireless communication modes comprise any mode of communication between points (e.g., nodes) that utilize, at least in part, wireless technology including various protocols and combinations of protocols associated with wireless transmission, data, and devices. The points comprise, for example, wireless devices such as wireless headsets, audio and multimedia devices and equipment, such as audio players and multimedia players, telephones, including mobile telephones and cordless telephones, and computers and computer-related devices and components, such as printers, network-connected machinery, and/or any other suitable device or third-party device.

Wired communication modes comprise any mode of communication between points that utilize wired technology including various protocols and combinations of protocols associated with wired transmission, data, and devices. The points comprise, for example, devices such as audio and multimedia devices and equipment, such as audio players and multimedia players, telephones, including mobile telephones and cordless telephones, and computers and computer-related devices and components, such as printers, network-connected machinery, and/or any other suitable device or third-party device. In various implementations, the wired communication modules can communicate in accordance with a number of wired protocols. Examples of wired protocols can include Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in various aspects, the communications interface 10 can include one or more interfaces such as, for example, a wireless communications interface, a wired communications interface, a network interface, a transmit interface, a receive interface, a media interface, a system interface, a component interface, a switching interface, a chip interface, a controller, and so forth. When implemented by a wireless device or within wireless system, for example, the communications interface 10 can include a wireless interface comprising one or more antennas, transmitters, receivers, transceivers, amplifiers, filters, control logic, and so forth.

In various aspects, the communications interface 10 can provide data communications functionality in accordance with a number of protocols. Examples of protocols can include various wireless local area network (WLAN) protocols, including the Institute of Electrical and Electronics Engineers (IEEE) 802.xx series of protocols, such as IEEE 802.11a/b/g/n/ac/ax/be, IEEE 802.16, IEEE 802.20, and so forth. Other examples of wireless protocols can include various wireless wide area network (WWAN) protocols, such as GSM cellular radiotelephone system protocols with GPRS, CDMA cellular radiotelephone communication systems with 1×RTT, EDGE systems, EV-DO systems, EV-DV systems, HSDPA systems, the Wi-Fi series of protocols including Wi-Fi Legacy, Wi-Fi 1/2/3/4/5/6/6E, and so forth. Further examples of wireless protocols can include wireless personal area network (PAN) protocols, such as an Infrared protocol, a protocol from the Bluetooth Special Interest Group (SIG) series of protocols (e.g., Bluetooth Specification versions 5.0, 6, 7, legacy Bluetooth protocols, etc.) as well as one or more Bluetooth Profiles, and so forth. Yet another example of wireless protocols can include near-field communication techniques and protocols, such as electro-magnetic induction (EMI) techniques. An example of EMI techniques can include passive or active radio-frequency identification (RFID) protocols and devices. Other suitable protocols can include Ultra-Wide Band (UWB), Digital Office (DO), Digital Home, Trusted Platform Module (TPM), ZigBee, and so forth.

In some embodiments, at least one non-transitory computer-readable storage medium is provided having computer-executable instructions embodied thereon, wherein, when executed by at least one processor, the computer-executable instructions cause the at least one processor to perform embodiments of the methods described herein. This computer-readable storage medium can be embodied in memory subsystem 8.

In some embodiments, the memory subsystem 8 can include any machine-readable or computer-readable media capable of storing data, including both volatile/non-volatile memory and removable/non-removable memory. The memory subsystem 8 can include at least one non-volatile memory unit. The non-volatile memory unit is capable of storing one or more software programs. The software programs can contain, for example, applications, user data, device data, and/or configuration data, or combinations therefore, to name only a few. The software programs can contain instructions executable by the various components of the system 2.

In various aspects, the memory subsystem 8 can include any machine-readable or computer-readable media capable of storing data, including both volatile/non-volatile memory and removable/non-removable memory. For example, memory can include read-only memory (ROM), random-access memory (RAM), dynamic RAM (DRAM), Double-Data-Rate DRAM (DDR-RAM), synchronous DRAM (SDRAM), static RAM (SRAM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information.

In one embodiment, the memory subsystem 8 can contain an instruction set, in the form of a file for executing various methods, such as methods for generating interfaces including at least one variant recommended item, as described herein. The instruction set can be stored in any acceptable form of machine-readable instructions, including source code or various appropriate programming languages. Some examples of programming languages that can be used to store the instruction set comprise, but are not limited to: Java, C, C++, C#, Python, Objective-C, Visual Basic, or .NET programming. In some embodiments a compiler or interpreter is comprised to convert the instruction set into machine executable code for execution by the processor subsystem 4.

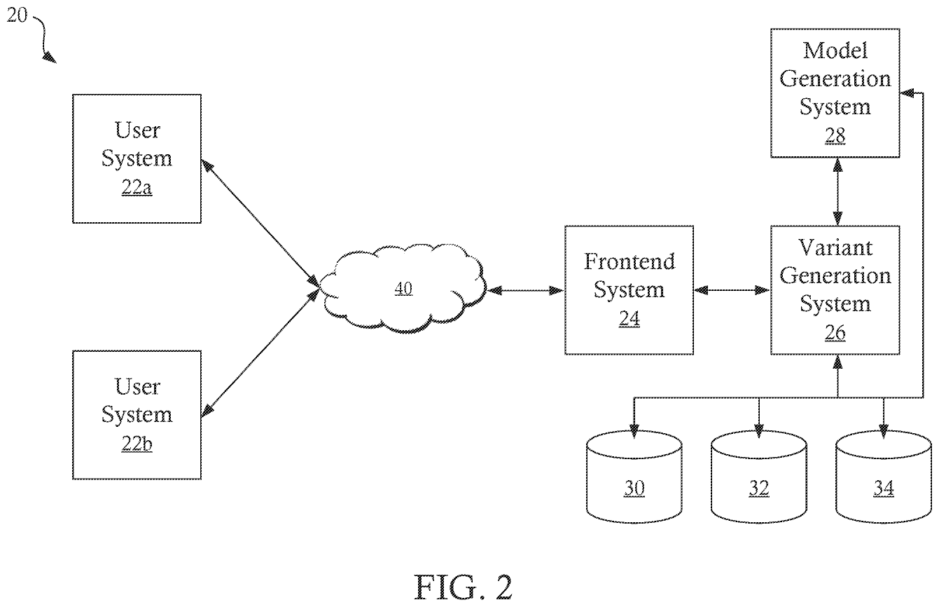

FIG. 2 illustrates a network environment 20 configured to provide network interfaces including at least one variant recommended item, in accordance with some embodiments. The network environment 20 includes a plurality of systems configured to communicate over one or more network channels, illustrated as network cloud 40. For example, in various embodiments, the network environment 20 can include, but is not limited to, one or more user systems 22a, 22b, a frontend system 24, a variant generation system 26, a model generation system 28, a variant score database 30, a variant-specific item features database 32, and a model store database 34. It will be appreciated that any of the illustrated systems can include a system as described above in conjunction with FIG. 1. Although specific embodiments are discussed, herein it will be appreciated that additional systems, servers, storage mechanism, etc. can be included within the network environment 20.

Further, although embodiments are illustrated herein having individual, discrete systems, it will be appreciated that, in some embodiments, one or more systems can be combined into a single logical and/or physical system. For example, in various embodiments, the frontend system 24, the variant generation system 26, the model generation system 28, the variant score database 30, the variant-specific item features database 32, and the model store database 34 can be combined into a single logical and/or physical system. Similarly, although embodiments are illustrated having a single instance of each system, it will be appreciated that additional instances of a system can be implemented within the network environment 20. In some embodiments, two or more systems can be operated on shared hardware in which each system operates as a separate, discrete system utilizing the shared hardware, for example, according to one or more virtualization schemes.

In some embodiments, the user systems 22a, 22b are configured to receive and/or generate a user interface to allow a user to interact with services and/or resources provided by a network system, such as frontend system 24. The user interface can include any suitable interface, such as, for example, a mobile device application interface, a network interface, and/or any other suitable interface. For example, in some embodiments, the frontend system 24 includes an interface generation engine configured to generate a customized network interface and provide the customized network interface, and/or instructions for generating the customized network interface, to a user system 22a, 22b, which displays the user interface via one or more display elements. The customized network interface can include any suitable network interface, such as, for example, an e-commerce interface, a service interface, an intranet interface, and/or any other suitable user interface. In some embodiments, the customized interface includes a webpage, web portal, intranet page, application page, and/or other interactive interface. The customized network interface includes at least one recommended content module selected, at least in part, by a trained contextual ranking model.

In some embodiments, the frontend system 24 is in signal communication with a variant generation system 26 configured to generate a set of recommended items including at least one variant item for inclusion in an interface. The frontend system 24 and/or the variant generation system 26 can implement a variant-aware ranking model configured to rank variants of items independently and/or individually based on a received search query and/or a user context. For example, in some embodiments, a variant-aware ranking model is configured to receive a variant-specific variant score and an item-specific relevance score and generate a ranking score based on a combination of the variant score and the relevance score. Although specific embodiments are discussed herein, it will be appreciated that any suitable variant-aware ranking model can be used.

In some embodiments, the variant generation system 26 is configured to generate variant scores for each variant of an item. For example, a variant generation system 26 can be configured to implement a variant score generation engine that generates a variant score for each variant of an item. The variant score can be based on any suitable variant-specific features. For example, in some embodiments, the variant score can be generated based on any suitable data, such as, for example, historic sales and/or engagement distributions of an item variant as compared to an item as a whole.

In some embodiments, trained models can be generated by a model generation system 28. The model generation system 28 is configured to generate one or more trained models using, for example, iterative training processes. For example, in some embodiments, a model training engine is configured to receive labeled variant scores and relevancy scores and generate a trained ranking model. As another example, in some embodiments, the model training system is configured to receive items having one or more variants and a set of variant scores and generate a trained variant score generation model. Generated models can be stored in any suitable storage mechanism, such as, for example, the model store database 34.

In various embodiments, the system or components thereof can comprise or include various modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the examples herein.

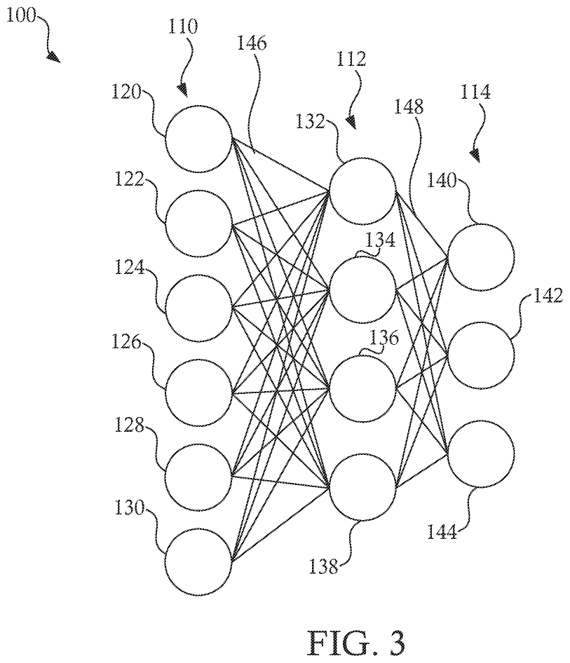

FIG. 3 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 3 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 can be arranged in layers 110-114, wherein the layers can comprise an intrinsic order introduced by the edges 146-148 between the nodes 120-144. In particular, edges 146-148 can exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 can be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number can be assigned as a value to every node 120-144 of the neural network 100. Here, xᵢ⁽ⁿ⁾ denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 can comprise a weight being a real number, in particular, the weight is a real number within the interval [−1, 1], within the interval [0, 1], and/or within any other suitable interval. Here, w_{i,j}^{(m,n)} denotes the weight of the edge between the i-th node 120-138 of the m-th layer 110, 112 and the j-th node 132-144 of the n-th layer 112, 114. Furthermore, the abbreviation w_{i,j}⁽ⁿ⁾ is defined for the weight w_{i,j}^{(n,n+1)}.

In particular, to calculate the output values of the neural network 100, the input values are propagated through the neural network. In particular, the values of the nodes 132-144 of the (n+1)-th layer 112, 114 can be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 can be calculated based on the values of the input layer 110 of the neural network and/or based on the values of a prior hidden layer, etc.

In order to set the values w_{i,j}^{(m,n)} for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers δⱼ⁽ⁿ⁾ can be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δⱼ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 114, wherein f is the first derivative of the activation function, and yⱼ⁽ⁿ⁺¹⁾ is the comparison training value for the j-th node of the output layer 114.

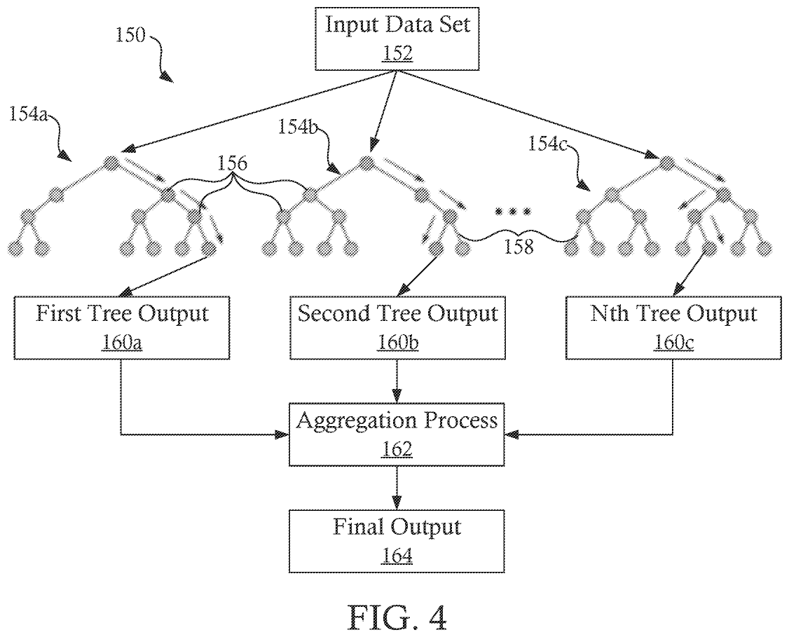

FIG. 4 illustrates a tree-based neural network 150, in accordance with some embodiments. In particular, the tree-based neural network 150 is a random forest neural network, though it will be appreciated that the discussion herein is applicable to other decision tree neural networks. The tree-based neural network 150 includes a plurality of trained decision trees 154a-154c each including a set of nodes 156 (also referred to as “leaves”) and a set of edges 158 (also referred to as “branches”).

Each of the trained decision trees 154a-154c can include a classification and/or a regression tree (CART). Classification trees include a tree model in which a target variable can take a discrete set of values, e.g., can be classified as one of a set of values. In classification trees, each leaf 156 represents class labels and each of the branches 158 represents conjunctions of features that connect the class labels. Regression trees include a tree model in which the target variable can take continuous values (e.g., a real number value).

In operation, an input data set 152 including one or more features or attributes is received. A subset of the input data set 152 is provided to each of the trained decision trees 154a-154c. The subset can include a portion of and/or all of the features or attributes included in the input data set 152. Each of the trained decision trees 154a-154c is trained to receive the subset of the input data set 152 and generate a tree output value 160a-160c, such as a classification or regression output. The individual tree output value 160a-160c is determined by traversing the trained decision trees 154a-154c to arrive at a final leaf (or node) 156.

In some embodiments, the tree-based neural network 150 applies an aggregation process 162 to combine the output of each of the trained decision trees 154a-154c into a final output 164. For example, in embodiments including classification trees, the tree-based neural network 150 can apply a majority-voting process to identify a classification selected by the majority of the trained decision trees 154a-154c. As another example, in embodiments including regression trees, the tree-based neural network 150 can apply an average, mean, and/or other mathematical process to generate a composite output of the trained decision trees. The final output 164 is provided as an output of the tree-based neural network 150.

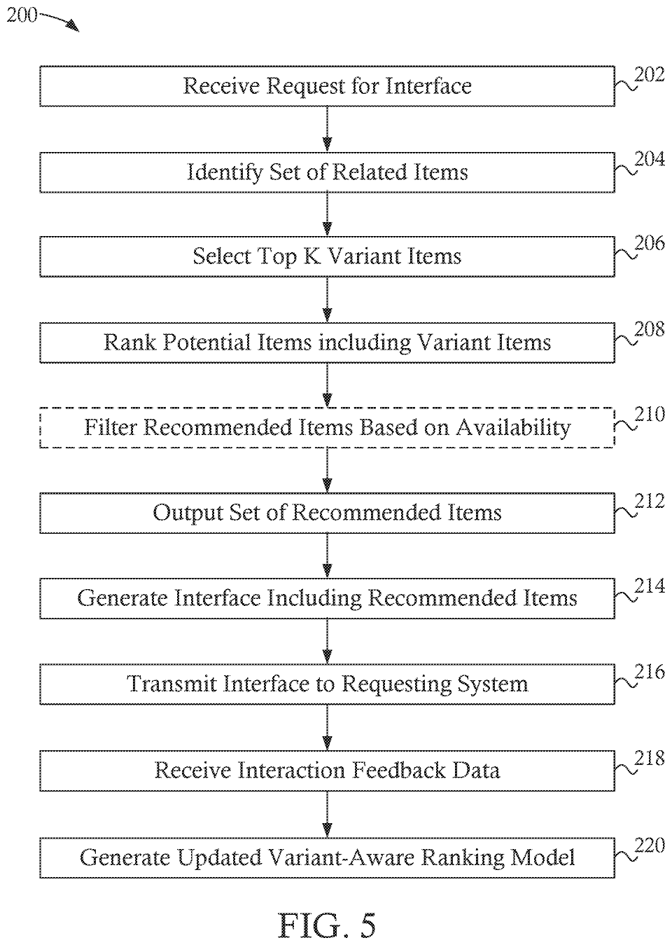

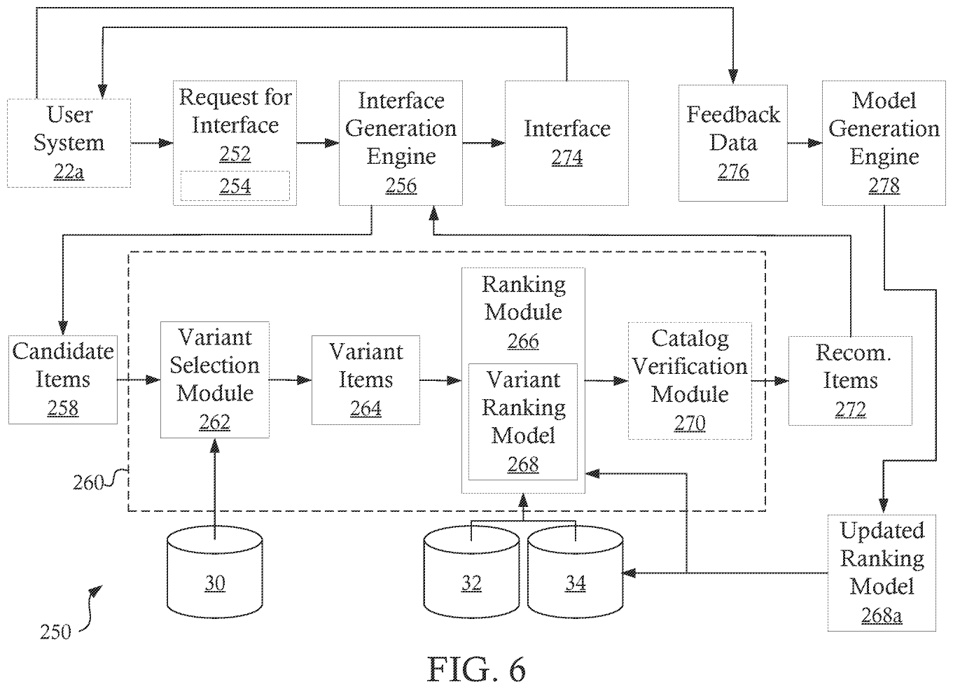

FIG. 5 is a flowchart illustrating a method 200 of generating an interface including one or more variant items, in accordance with some embodiments. FIG. 6 is a process flow 250 illustrating various steps of the method of generating an interface including one or more variant items, in accordance with some embodiments. At step 202, a request 252 for an interface is received. The request 252 can be received by any suitable system, such as, for example, a frontend system 24. In some embodiments, the request 252 includes user data, such as, for example, a user identifier, context data, and/or any other suitable user data. The user data can be generated by any suitable mechanism, such as, for example, a cookie, beacon, and/or other identifier stored on and/or provided to a user system 22a, 22b.

In some embodiments, the request 252 for an interface includes a search query 254 requesting one or more responsive items from a catalog associated with a network interface. The search query 254 can include a textual search query, an item identifier, and/or any other suitable search query. The search query 254 identifies an anchor item, target item, target content, and/or other search definition for identifying and providing content items from the catalog associated with the network interface. In some embodiments, a search query 254 can be replaced with any other suitable content identifier such as a prior viewed item, concurrently viewed item, etc.

At step 204, a set of candidate items 258 is identified. The set of candidate items includes one or more of the items having two or more variants. For example, in some embodiments, the set of candidate items 258 includes at least one item having variations in one or more features, such as variations in size, color, source, materials, etc. The variations define different versions of an item that are traditionally grouped together as a single item within the catalog and search results. Common examples of variations in an e-commerce catalog include, but are not limited to, size variants, color variants, flavor variants, graphic variants, etc. Items can include multiple variant features, such as an item having both variant size and color options. It will be appreciated that any suitable variation of an item can be defined as a variant within the scope of this disclosure.

In some embodiments, the set of candidate items 258 includes an entire catalog of potential items. For example, the disclosed variant-aware ranking model discussed below can be used as a stand-alone search engine or system configured to identify items within a catalog. In such embodiments, the set of candidate items 258 is all possible items that can be returned for a search query 254 or other request 252. The set of related items can include all items in a catalog, items within a specific predefined portion of a catalog, promoted or preselected items, and/or any other defined set of items or content elements within a catalog.

In some embodiments, the set of candidate items 258 can include a limited or curated set of item identified and/or selected using any suitable selection process, such as, for example, a traditional searching process, a semantic matching process, a catalog selection process, etc. The set of candidate items 258 can represent a set of recommended items selected based on user-related information, such as user context, user interaction history, user preferences, etc. As another example, in some embodiments, the set of candidate items 258 can include a set of promoted items selected for inclusion in generated interfaces. Although specific embodiments are discussed herein, it will be appreciated that the set of candidate items 258 can include any defined set of items selected from a catalog associated with a network interface.

In some embodiments, the set of candidate items 258 is selected by a traditional item recommendation process configured to provide recommendations based solely on a single version of an item. For example, current systems are configured to prevent repeat search results by allowing only a single version of an item to be retrieved for recommendation purpose. In such systems, a recommended item can be matched based on an existing variant, e.g., a search for a red shirt can produce an item that has a red variant, but will be displayed based only on the selected single version of the item. The selected version of the item may not match the context or target of the search. For example, to continue the prior example, the search version of the item provided as a recommended item can be a gray variant of a shirt, which would not match the context of a search for a “red shirt.” In some embodiments, the set of candidate items 258 is provided to a recommendation engine 260.

At step 206, a set of variant items 264 is selected based on the set of candidate items 258. In some embodiments, the set of variant items 264 is selected by a variant selection module 262. The variant selection module 262 can include a ranking or other module configured to select a set of variants for each item within the set of candidate items 258. For example, in some embodiments, the variant selection module 262 is configured to obtain a variant score associated with each item variant. The variant score can be representative of any suitable features or attributes of the variant and can be provided with respect to a catalog as a whole, a portion of a catalog, and/or in relation to other variants of an item. For example, in some embodiments, the variant score is generated based on historical sales of the specific item variant and/or interaction/engagement data for the specific item variant. In some embodiments, variant scores can be obtained from a variant score database 30.

The variant score for each item variant can be precalculated and/or can be determined in real time. In some embodiments, a backend or batch process can be configured to calculate a variant score for each item variant in an item catalog at a predetermined interval, such as once a day, once a week, etc. The precalculated variant scores can be stored in a database, such as the variant score database 30, and retrieved by a variant selection module 262 in real time. As another example, in some embodiments, the variant selection module 262 can calculate variant scores for item variants in real-time for each item in the set of candidate items 258.

In some embodiments, the set of variant items 264 includes a predetermined number of variant items for each item in the set of candidate items 258. For example, the variant selection module 262 can be configured to identify a set of top K variants for each item, where K is a positive integer. In some embodiments, the variant selection module 262 is omitted and the set of items 258 and variant scores for each potential variant is provided directly to the ranking module 266 for ranking, as discussed in greater detail below.

At step 208, a set of recommended items 272 including at least one item variant not included in the set of candidate items 258 is generated. In some embodiments, a variant-aware ranking model 268 implemented by a ranking module 266 is configured to receive one or more inputs, such as, for example, the set of variant items 264, variant scores for each variant in the set of variant items 264, and item features for each variant in the set of variant items 264, and generate a set of ranked recommended items 272. In some embodiments, the ranking module 266, such as the variant-aware ranking model 268, is configured to generate a relevancy score for each variant in the set of variants items 264.

In some embodiments, a relevancy score is representative of a relevance of a specific item variant to a current context. The context can include, but is not limited to, a semantic context based on a semantic input such as a search query or search term, a user context based on user interaction and/or user journey data, interaction or engagement data, etc. In some embodiments, multiple relevancy scores, such as a general item relevancy score and a variant relevancy score, can be generated and used by the variant-aware ranking model 268.

In some embodiments, the relevancy score is generated based on item features identified for each variant item in the set of variant items 264. Item features can include item-generic features and variant-specific features. Item-generic features can include features shared by all variants of an item. For example, in an e-commerce environment, item-generic features can include, but are not limited to, brand, department, item type (e.g., shirt, pants, ring, shoes, etc.), style identifiers, etc. In contrast, variant-specific features can include features that define item variations. For example, in an e-commerce environment, variant-specific features can include, but are not limited to, size, color, material, flavor, etc. Although specific embodiments are discussed herein, it will be appreciated that any set of item features can be used to determine a relevancy score.

In some embodiments, item feature data can be retrieved from a database, such as a variant-specific item feature database 32. A backend or batch process can be configured to extract features for each item variant in an item catalog at a predetermined interval, such as once a day, once a week, etc. The extracted features can be stored in a database, such as the variant-specific item feature database 32, and retrieved by the ranking module 266 in real time. As another example, in some embodiments, the variant-aware ranking model 268 can extract item features in real-time for each item in the set of variant items 264.

In some embodiments, the ranking module 266 is configured to obtain one or more trained variant-aware ranking models 268 from a model store, such as model store database 34. The trained variant-aware ranking models 268 ca be generated by any suitable system utilizing an iterative training process, as discussed in greater detail below. A trained variant-aware ranking model 268 can be based on any suitable machine learning framework, such as, for example, vector-space models, learning to rank models, (e.g., a pointwise ranking framework, a pairwise ranking framework, and/or a listwise ranking framework), a deep learning ranking framework, and/or any other suitable ranking framework.

In some embodiments, the variant-aware ranking model 268 is configured to generate item rankings based on additional features or metrics, such as item engagement metrics, organic features, item features, and/or variant-specific engagement metrics. As discussed above, item engagement metrics can include, but are not limited to, interaction metrics generated for interface items including an item, such as a default version of an item, an aggregate of interaction for all variations of an item, etc. The Item engagement metrics can include interface interaction features such as click through rate, add-to-cart rate, and/or any other suitable measurable interface interaction. Similarly, as discussed above, item features can include item-generic features and/or variant-specific features. Further, and as discussed above, variant-specific engagement metrics can include interaction metrics for specific variants of an item.

In some embodiments, organic features can include user-generated and/or user-modified features associated with items. For example, organic features can include user-generated reviews, user-generated ratings, third-party generated reviews, third-party generated ratings, etc. Although specific embodiments are discussed herein, it will be appreciated that any suitable organic features can be used by a variant-aware ranking model 268. In some embodiments, the use of organic features is omitted.

At optional step 210, the set of ranked items generated by the variant-aware ranking model 268 is filtered to include only those items currently available in a related item catalog. In some embodiments, a catalog verification module 270 is configured to verify the availability of each specific variant in the ranked set of variant items. If a variant item is not available, the variant is removed from the ranked set and omitted from the set of recommended items 272. For example, in the context of an e-commerce environment, a catalog verification module 270 can implement an inventory verification process configured to verify the availability of a specific item variant in a physical inventory related to the network interface. A physical inventory can include, but is not limited to, a store-specific inventory, a warehouse-specific inventory, a general inventory, etc. The inventory information can be provided by any suitable system, such as an inventory control system in signal communication with a system implementing the recommendation engine 260, such as a variant generation system 26. As another example, in the context of a catalog of interface pages, the catalog verification module 270 can be configured to verify the current availability of an interface page related to a variant item included in the ranked set of variant items.

At step 212, a set of recommended items 272 is output from the recommendation engine 260. In some embodiments, the set of recommended items 272 includes a ranked list of items (e.g., data identifying items in a catalog of items and/or interface elements related to the identified items) including at least one variant item not included in the set of candidate items 258. For example, in some embodiments, the set of recommended items 272 can include a variant item having a variable item feature value, such as a color, size, etc., that is different from the value of that item feature in the set of candidate items 258.

At step 214, an interface 274 including the set of recommended items 272 is generated. The interface 274 can be generated by an interface generation engine 256. In some embodiments, the interface generation engine 256 is configured to obtain a default interface page or a template interface page and populate the template with interface elements, including one or more interface elements incorporating and/or representative of items in the set of recommended items 272. For example, in some embodiments, an interface page template includes a predefined portion configured to receive recommended item content, such as a banner, carousel, and/or other interface element configured to include recommended items. It will be appreciated that the interface can include any suitable presentation of the set of recommended items 272, such as a list, carousel, banner, etc.

In some embodiments, the interface generation engine 256 is implemented by a third party website provider, such as a search provider. The set of recommended items 272 can include sponsored or recommended items for inclusion within an interface generated by a third party provider. For example, in some embodiments, one or more of the recommended items 272 can be selected by a third party provider for inclusion within an interface according to any suitable criteria implemented by the third party provider. At step 216, the interface 274 is provided to the system that generated the request 252, such as a user system 22a.

Identification of relevant content on an interface, such as identifying items within a large catalogs of items associated with a network interface, to locate specific items of interest can be difficult and time consuming for users. Typically, users navigate a predefined browse structure, sometimes referred to as a “browse tree,” in which interface elements, such as pages or items, are arranged in a predetermined hierarchy, such as by categories or sub-categories. Such browse trees typically include multiple levels, requiring users to navigate through several levels of nodes to reach an item of interest. Thus, the user must perform multiple navigational steps to find items of interest and/or pages including items of interest.

Variant-aware ranking models configured to rank variant items independently, as disclosed herein, significantly reduce this problem, allowing users to locate items of interest with fewer steps. For example, in some embodiments described herein, when a user is presented with recommended items, each item includes, or is in the form of, a link to an interface page corresponding to the item of interest, e.g., an item page. Each item thus serves as a programmatically selected navigational shortcut to an interface page, allowing a user to bypass the typical navigational structure. Such shortcuts allow a user to bypass the browse tree structure and improve the speed of the user's navigation through an electronic interface. This can be particularly beneficial for computing devices with small screens, where fewer interface elements can be displayed to a user at a time and thus navigation of larger volumes of data is more difficult.

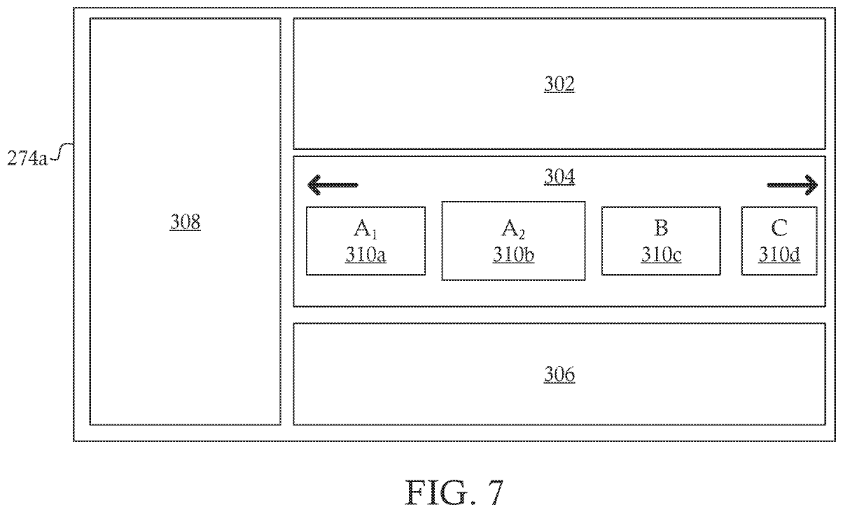

FIG. 7 illustrates an interface 274a including content elements 302a, 302b representative of variant items, in accordance with some embodiments. As illustrated in FIG. 7, the interface 274a includes a header section 302, a recommended item container 304, a footer section 306, and a sidebar 308. Although specific embodiments of the interface 274a are illustrated, it will be appreciated that any suitable interface elements and/or containers can be included. The item container 304 includes content elements 310a-310d representative of a set of recommended items 272. The content elements 310a-310d include a first element 310a and a second element 310b representative of variants of the same item. For example, in the illustrated embodiment, the first element 310a is representative of first variant, A₁, of an item in an item catalog and the second element 310b is representative of a second variant, A₂, of the item. The third element 310c is related to a second item B and the fourth element 310d is related to a third item C.

The illustrated interface 274a can include content elements 310a, 310b representative of variant items that provide a better match to a user context as compared to a default or base version of an item. Interfaces generated according to the systems and methods provided herein provide diversity in items presented within the interface while simultaneously presenting content elements representative of variant recommended items that are a close match to a user context.

With reference again to FIGS. 5-6, At optional step 218, feedback data 276 is received from the user system 22a. The feedback data 276 is indicative of a user interaction with the generated interface 274. Feedback data 276 can include, but is not limited to, interaction metrics such as click rates, add-to-cart, etc. The feedback data 276 can be provided directly from the user system 22a and/or can be obtained implicitly from interactions between the user system 22a and a system, such as the frontend system 24. In some embodiments, the feedback data 276 can be stored in a database.

At optional step 220, an updated variant-aware ranking model 268a is generated and deployed to the recommendation engine 260 for use in generating sets of recommended items 272. The updated variant-aware ranking model 268a can be generated by a model generation engine 278 implemented by any suitable system, such as, for example, the model generation system 28. As discussed in greater detail below, the model generation engine 278 is configured to implement an iterative training process to generate variant-aware ranking models 268, 268a. The model generation engine 278 is configured to receive the feedback data 276 and utilize the feedback data 276 to update or retrain an updated variant-aware ranking model 268a.

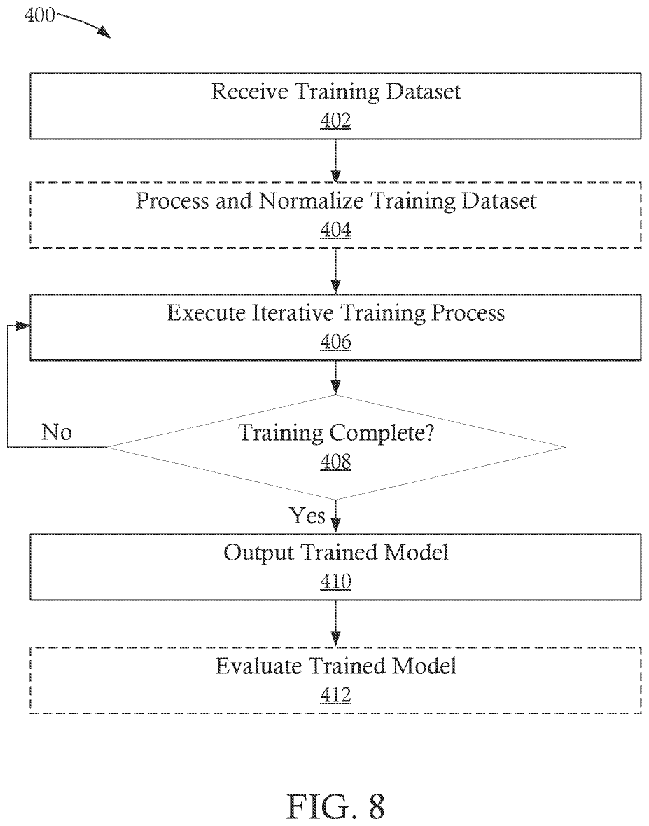

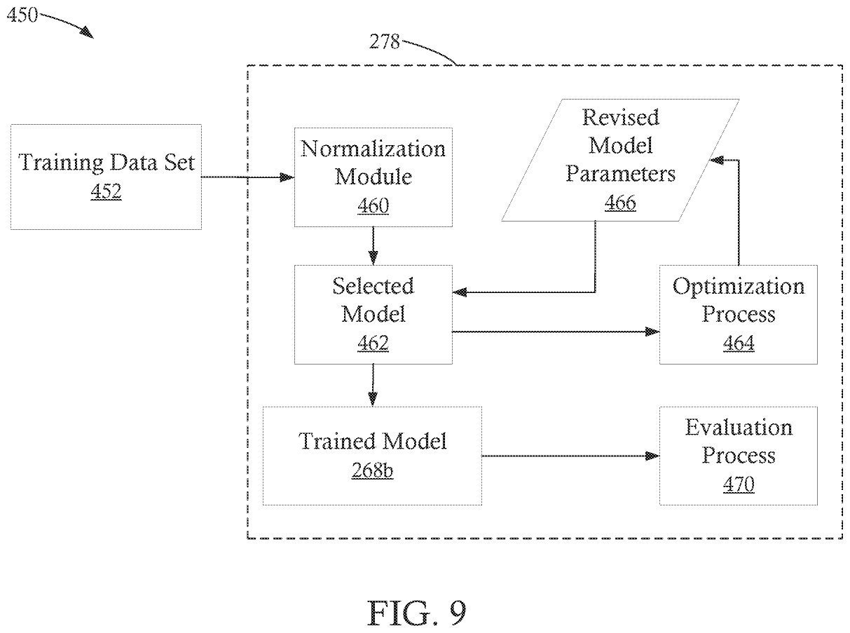

In some embodiments, a trained variant-aware ranking model 268, 268a is generated using an iterative training process based on a training dataset. FIG. 8 illustrates a method 400 for generating a trained variant-aware ranking model in accordance with some embodiments. FIG. 9 is a process flow 450 illustrating various steps of the method 400 of generating a trained variant-aware ranking model, in accordance with some embodiments. At step 402, a training dataset 452 is received by a system, such as model generation system 28. The training dataset 452 can include labeled and/or unlabeled data. For example, in some embodiments, a set of labeled and/or semi-labeled data is provided for use in training a variant-aware ranking model.

In some embodiments, the training dataset 452 includes historical interaction data. The historical interaction data can include data representative of interaction between one or more users with one or more generated interface pages, such as views, click rates, add-to-cart, etc. Historical interaction data can include item-generic interaction data, e.g., data representative of all interactions with any variation of an item and/or any content element including a variation of an item and/or variant-specific interaction data.

In some embodiments, the training dataset 452 includes item feature data. The item feature data can include one or more item features extracted for one or more variants of an item included in the training dataset 452. As discussed above, item features can include item-generic and variant-specific features. In the context of an e-commerce environment, the item features can include, but are not limited to, brand, style, department, size, color, material, finish, etc.

In some embodiments, the training dataset 452 includes at least partially labeled training data such that the training dataset 452 consists of input training data including at least a first portion of the sequence unit training data 454 representative of initial, intermediate, first, and/or prior states and the user feature training data 456 and target, or output, training data including a portion of the sequence unit training data 454 representative of intermediate, second, and/or final states. In some embodiments, the training dataset 452 includes identifiers for obtaining features from pre-existing feature sets stored in one or more storage locations. For example, in some embodiments, the training dataset 452 can include a set of reference identifiers for retrieving features from a relevant database, such as a variant-specific item feature database 32.

In some embodiments, the training dataset 452 includes precalculated variant scores and/or relevancy scores. The precalculated scores can include training input, e.g., scores configured to be received by a ranking model as an input, and/or as target outputs, e.g., precalculated target scores for calculating a loss function of a model during iterative training. The variant scores and/or the relevancy scores can be generated using any suitable process, such as a previously generated model, algorithm etc.

At optional step 404, the received training dataset 452 is processed and/or normalized by a normalization module 460. For example, in some embodiments, the training dataset 452 can be augmented by imputing or estimating missing values of one or more features associated with a variant item. In some embodiments, processing of the received training dataset 452 includes outlier detection configured to remove data likely to skew training of a variant-aware ranking model. In some embodiments, processing of the received training dataset 452 includes removing features that have limited value with respect to training of the variant-aware ranking model, such as features that are common across multiple items and/or variations.

At step 406, an iterative training process is executed to train a selected model 462. The selected model 462 can include an untrained (e.g., base) machine learning model, such as a vector-space framework, a learning to rank framework, or a deep learning framework, and/or a partially or previously trained model (e.g., a prior version of a trained variant-aware ranking model, a partially trained model from a prior iteration of a training process, etc.). The training process is configured to iteratively adjust parameters (e.g., hyperparameters) of the selected model 462 to minimize a cost value (e.g., an output of a cost function) for the selected model 462. In some embodiments, the cost value is related to a match between predicted behavior, e.g., a predicted interaction such as a click through or add-to-cart, and actual interaction behavior.

The training process is an iterative process that generates set of revised model parameters 466 during each iteration. The set of revised model parameters 466 can be generated by applying an optimization process 464 to the cost function of the selected model 462. The optimization process 464 can be configured to reduce the cost value (e.g., reduce the output of the cost function) at each step by adjusting one or more parameters during each iteration of the training process.

After each iteration of the training process, at step 408, a determination is made whether the training process is complete. The determination at step 408 can be based on any suitable parameters. For example, in some embodiments, a training process can complete after a predetermined number of iterations. As another example, in some embodiments, a training process can complete when it is determined that the cost function of the selected model 462 has reached a minimum, such as a local minimum and/or a global minimum.

At step 410, a trained variant-aware ranking model 268b is output and provided for use in an interface generation method, such as the method 200 discussed above with respect to FIGS. 5-6. The trained variant-aware ranking model 268b is configured to generate a set of recommended items 272 included at least one variant item. At optional step 412, a trained variant-aware ranking model 268b can be evaluated by an evaluation process 472. The trained variant-aware ranking model 268b can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model.

Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory;
a processor communicatively coupled to the non-transitory memory, wherein the processor is configured to read a set of instructions to:
receive a request for an interface;
receive a set of candidate items selected from an item catalog, wherein at least one of the candidate items is representative of two or more variant items in the item catalog;
determine a variant score for each variant item related to the at least one of the candidate items;
generate a set of recommended items by independently ranking each item in the set of candidate items and each of the two or more variant items, wherein the set of recommended items is generated by a variant-aware ranking model configured to receive the variant score for each variant item, and wherein the set of recommended items is generated based on the variant score and a relevancy score for each variant item;
generate the interface including the set of recommended items; and
transmit the interface to a system that generated the request for the interface.

2. The system of claim 1, wherein the variant score is determined based on historical sales of the variant item and interaction data for the variant item.

3. The system of claim 1, wherein the variant-aware ranking model is configured to generate the relevancy score.

4. The system of claim 1, wherein the request for the interface includes a contextual identifier, and wherein the relevancy score is generated based on a correspondence between each variant item and the contextual identifier.

5. The system of claim 1, wherein the processor is further configured to read the set of instructions to, prior to generating the interface, filter the set of recommended items based on current availability of each variant item.

6. The system of claim 1, wherein the variant score for each variant item is precalculated by a batch process.

7. The system of claim 1, wherein the processor is further configured to read the set of instructions to:
receive feedback data indicative of one or more interactions with the interface;
iteratively train an updated variant-aware ranking model based at least in part on the feedback data; and
store the updated variant-aware ranking model in a model store database.

8. The system of claim 1, wherein the set of recommended items includes each of the two or more variant items.

9. A computer-implemented method, comprising:
receiving a request for an interface;
receiving a set of candidate items selected from an item catalog, wherein at least one of the candidate items is representative of two or more variant items in the item catalog;
determining a variant score for each variant item related to the at least one of the candidate items;
generating a set of recommended items by independently ranking each item in the set of candidate items and each of the two or more variant items, wherein the set of recommended items is generated by a variant-aware ranking model configured to receive the variant score for each variant item, and wherein the set of recommended items is generated based on a relevancy score for each variant item;
generating the interface including the set of recommended items; and
transmitting the interface to a system that generated the request for the interface.

10. The computer-implemented method of claim 9, wherein the variant score is determined based on historical sales of the variant item and interaction data for the variant item.

11. The computer-implemented method of claim 9, wherein the variant-aware ranking model is configured to generate the relevancy score.

12. The computer-implemented method of claim 9, wherein the request for the interface includes a contextual identifier, and wherein the relevancy score is generated based on a correspondence between each variant item and the contextual identifier.

13. The computer-implemented method of claim 9, comprising, prior to generating the interface, filtering the set of recommended items based on current availability of each variant item.

14. The computer-implemented method of claim 9, wherein the variant score for each variant item is precalculated by a batch process.

15. The computer-implemented method of claim 9, comprising:
receiving feedback data indicative of one or more interactions with the interface;
iteratively training an updated variant-aware ranking model based at least in part on the feedback data; and
storing the updated variant-aware ranking model in a model store database.

16. The computer-implemented method of claim 9, wherein the set of recommended items includes each of the two or more variant items.

17. A non-transitory computer-readable medium having instructions stored thereon which, when executed by a processor, cause a device to perform operations comprising:
receiving a request for an interface;
receiving a set of candidate items selected from an item catalog, wherein at least one of the candidate items is representative of two or more variant items in the item catalog;
determining a variant score for each variant item related to the at least one of the candidate items;
generating, by a variant-aware ranking model, a relevancy score for each variant item;
generating a set of recommended items by independently ranking each item in the set of candidate items and each of the two or more variant items, wherein the set of recommended items is generated by a variant-aware ranking model configured to receive the variant score for each variant item, and wherein the set of recommended items is generated based on the variant score and the relevancy score for each variant item;
generating the interface including the set of recommended items; and
transmitting the interface to a system that generated the request for the interface.

18. The non-transitory computer-readable medium of claim 17, wherein the variant score is determined based on historical sales of the variant item and interaction data for the variant item.

19. The non-transitory computer-readable medium of claim 17, wherein the request for the interface includes a contextual identifier, and wherein the relevancy score is generated based on a correspondence between each variant item and the contextual identifier.

20. The non-transitory computer-readable medium of claim 17, wherein the instructions further cause the device to perform operations comprising, prior to generating the interface, filtering the set of recommended items based on current availability of each variant item.
